(19) United States
(12) Patent Application Publication
(10) Pub. No.: US 2004/0025714 A1
(43) Pub. Date: Feb. 12, 2004

(54) Smoker for a barbecue grill

(76) Inventors: Ryan Neal, Midland, GA (US); Andrew Kahler, Fortson, GA (US); Scott Dobias, Columbus, GA (US); Kenneth Jordan, Columbus, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/214,348

(22) Filed: Aug. 7, 2002

(51) Int. Cl. A47J 9/00; A23B 4/03

(52) U.S. Cl. 99/482; 99/450

(57) ABSTRACT

A barbecue grill smoker for placement in a barbecue grill to produce a flavored smoke when heated. The smoker includes a heat resistant receptacle with an interior cavity for receiving a flavored smoke source. The receptacle has a lid with a smoker control mechanism that serves to regulate the release rate of the smoke via a plurality of aligning apertures and openings that are moved from an open to closed position.

### TECHNICAL FIELD

The present invention is generally related to barbecue grills and, more particularly, to a smoker for placement in a barbecue grill for controlling the amount of smoke released from the smoker during the grilling and smoking processes.

### BACKGROUND OF THE INVENTION

Outdoor cooking has become increasingly popular over the past several years as is evident by the extensive line of outdoor cooking devices developed each year. The barbecue grill is especially versatile offering many different fuel choices to the outdoor chef. Gas and electric barbecue grills offer convenient fuel sources with an associated ease of clean-up not found with wood and charcoal. Some grilling enthusiasts prefer charcoal or wood fired grills, but these require extra storage space for the fuel source and an increase in the food preparation time. The gas and electric fuel sources, however, do not produce a Favorable smoke that is often preferred in the outdoor cooking of meats and fish in particular. An entire assortment of wood chips has been developed to give that special smoky flavor preferred for the grilling of certain selected meats and fishes. For example, mesquite and hickory chips are often used for cooking pork ribs, or beef while alder chips are recommended, because of their subtle flavor, for such favorites as smoked salmon and trout. Various devices are available for holding the wood chips when placed in the barbecue grill itself, but none of the devices have the capability of controlling the amount of smoke released within the grill while the food is being cooked.

Examples of currently available barbecue grill smokers include a ducted smoker described in U.S. Pat. No. 6,257,130 where the smoker assembly provides for the dispersement of smoke throughout the grilling chamber. The smoker assembly has a lid which may contain apertures for dispersing the smoke, but the dispersement of the smoke can not be regulated through the apertures, if they are even present, in the lid or cover. U.S. Pat. No. 6,102,028 describes a smoker attachment having a plurality of openings in side walls of the attachment for dispersing the smoke throughout the grill. The attachment has a lid with a plurality of apertures that allow the smoke to escape into the grill. The apertures are fixed in the open position and thus can not be used to control the amount or the rate of smoke escaping into the grill interior. U.S. Pat. No. 6,059,849 describes a barbecue smoker device for barbecue grills which holds pre-soaked wood chips, having a lid which is partially removable to allow the smoke from the wood chips to escape. The partial removal of the lid is similar to that of a removable pop-top where a portion of the lid is merely popped to a partially opened position.

None of the devices described above have the capability of decreasing the number of apertures or modifying the size of the apertures to control the amount of smoke released from the smoker device. Thus, a heretofore unaddressed need exists in the industry to address the aforementioned deficiencies and inadequacies.

### SUMMARY OF THE INVENTION

Briefly described, the barbecue grill smoker of the present invention provides an easily removable smoker for placement in a barbecue grill having a receptacle for the placement of a flavor source, generally wood chips, and a lid containing a smoker control mechanism for regulating the rate of release of flavored smoke from the smoker receptacle into the barbecue grill.

The barbecue grill smoker includes at least one aperture and at least one opening in the lid which are located respectively, each on one of at least two surfaces and in an aligning relationship to permit the smoker control mechanism to move from an open position, through a series of partially open positions, and to a closed position. Each position provides for a different rate of release of flavored smoke.

Other objects, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a barbecue grill smoker according to an embodiment of the present invention;

FIG. 2 is a perspective view of the barbecue grill smoker similar to FIG. 1, with the lid in its open position; and

FIG. 3 is a perspective view of the barbecue grill smoker positioned within a barbecue grill, the barbecue grill being shown in phantom.

### DETAILED DESCRIPTION OF THE PREFERRED EMBODIMENT

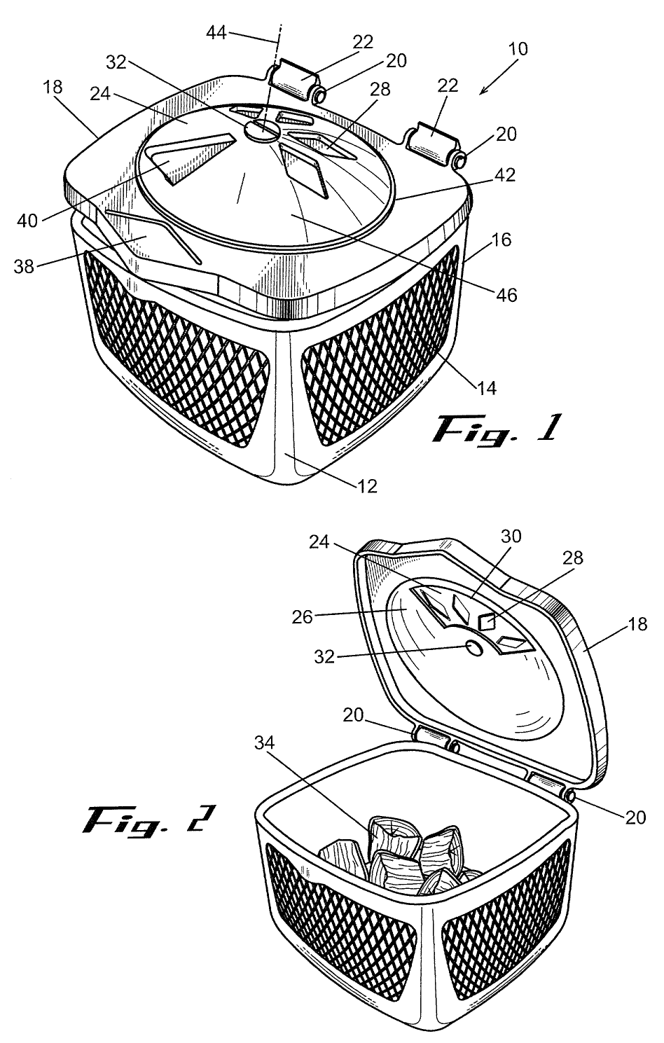

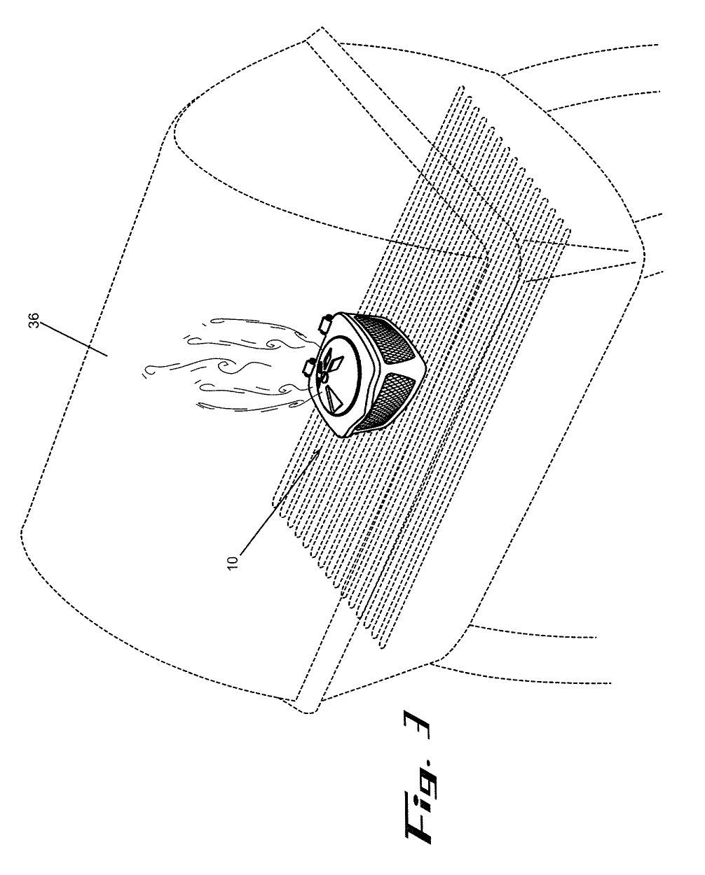

FIG. 1 shows a barbecue grill smoker 10 having receptacle 12 with an inner cavity 14 surrounded by side wall 16 for receiving a flavored smoke source, e.g., wood chips 34 as shown in FIG. 2. Receptacle 12 can be constructed of any heat resistant material, such as, cast iron, stainless steel, brass or the like. Lid 18 is hingedly mounted to receptacle 12 via hinge mounts 20 secured to side wall 16. The embodiment shown in FIG. 1 shows two hinge mounts but it will be understood that the number of hinge mounts could vary. Hinge mounts 20 have hinge mount stops 22 permitting lid 18 to be opened to a vertical position shown in FIG. 2 to facilitate the loading or removal of the wood chips. While hinge mounts are shown as the mounting means for attaching the lid to the receptacle, as one having ordinary skill in the art will appreciate any commonly available mounting means could be used.

Lid 18 is shown in FIG. 1 to have a means for selectively opening or closing the receptacle, such as a smoker control mechanism 46 positioned in the approximate center of lid 18. The smoker control mechanism 46 has a first surface 24 which contains at least one aperture 28 cut into and extending through surface 24. While the embodiment shown in FIG. 1 has four diamond-shaped apertures 28, it will be understood that the number of apertures may vary and other geometric shapes such as squares, rectangles, triangles, etc. may be used. First surface 24 is rotatable and is secured to a second surface 26 shown in FIG. 2, via securing means 32 which permits first surface 24 to rotate in a circular fashion about a central axis 44. Securing means 32 can be any means available in the art for securing first surface 24 to second surface 26 to permit the desired rotation. Such securing means includes screws, rivets, flattened head pins or the like. Rotation fin 40 is provided for effecting rotation and is illustrated in FIG. 1 as an elevated ridge which permits the barbecue chef to use whatever cooking utensils are available to rotate surface 24 about its central axis by pushing against fin 40. Furthermore, surface 24 is slideably positioned in channel 42 which is provided to facilitate the rotation of first surface 24 about axis 44. Second surface 26 is better illustrated in FIG. 2 as a stationary surface positioned below first surface 24 in a spaced apart relationship. Second surface 26 contains opening 30, shown in FIG. 2, as a circular ring sector having dimensions that correspond approximately to those defined by apertures 28. When lid 18 is fully closed and first surface apertures 24 are aligned with stationary opening 30, smoker control mechanism 46 is in its open position and the maximum amount of smoke will escape through aligned apertures 28 and opening 30 into the interior of the barbecue grill. When smoker control mechanism 46 is in its closed position, apertures 28 and opening 30 are completely out of alignment and little or no smoke escapes into the barbecue grill. Intermediate positions (not shown) of smoker control mechanism 46 can be visualized by a rotation of first surface 24 about central axis 44 where a partial alignment of apertures 28 with opening 30 occurs and only a portion of the apertures 28 are aligned with opening 30. Rotation stop (not shown), is positioned on the underside of first surface 24 to abut stationary stop (not shown) positioned on the topside of second surface 26 when the smoker control mechanism is in its open position. The rotation stop and the stationary stop prevent first surface 24 from rotating freely about central axis 44. When said stops are in an abutting relationship, smoker control mechanism 46 is in its open position.

It will be appreciated from the views illustrated in FIGS. 1 and 2 that an important feature of the embodiment illustrated therein is the easy ability to rotate smoker control mechanism 46 about central axis 44 to alter the alignment of respective apertures 28 and opening 30 to control the amount of smoke escaping from receptacle 12 during the cooking process without opening lid 18. If during the cooking process, it becomes necessary to add additional wood chips, lid 18 is provided with lip 38 which extends outwardly over side wall 16 of receptacle 12 to allow the chef to raise the lid, with any conveniently available cooking utensil, to its open position, add more chips and then close lid 18 again without having to remove the barbecue grill smoker from the grill. Should there be a need to provide more air into the receptacle 12, to accelerate combustion therein, one merely rotates first surface 24 to its open position using rotation fin 40.

Lid 18 can be constructed of any light weight heat resistant material such as stainless steel, brushed aluminum or the like. Lip 38 extends outwardly to enable the lifting of the lid for either the placement of the wood chips inside receptacle 12 or for easy removal when the smoking process is complete. If the lid is still hot, as discussed above, any convenient cooking utensil can be used for raising or lowering lid 18.

While the embodiment illustrated in FIGS. 1 and 2 shows first surface 24 having a dome-shaped configuration and being rotatable about central axis 44 and surface 26 as stationary and positioned below first surface 24, it will be appreciated that in another embodiment, first surface 24 could be stationary and second surface 26 could be rotatable. A means for rotation could be attached to second surface 26, extending upward above surface 24, to be rotated by any available cooking utensil to move the smoker control mechanism between its open and closed positions. In another embodiment, rather than having a first surface rotatably oriented to a second surface, one of the surfaces could be slideably oriented to the other surface, each surface containing respectively aligning apertures to permit the smoker control mechanism to move between its open and closed positions.

A further embodiment of the barbecue grill smoker 10 provides for the dimensions of the apertures and openings in the lid, when aligned, to be of sufficient size to permit the refilling of the receptacle with wood chips if needed during the smoking process without removing lid 18.

To use the barbecue grill smoker 10 of the present invention with the barbecue grill 36 shown in FIG. 3, one merely places the wood chips in receptacle 12 while lid 18 is in its open position. It may be desirable to keep the lid open when first placing the smoker on the grill to maximize the amount of air passing above the wood chips until they begin to smoke. Lid 18 is then closed. Smoker control mechanism 46 is initially placed in its open position where apertures 28 in rotatable surface 24 are aligned with opening 30 in stationary surface 26 as shown in FIG. 3. As the grill heats, the wood chips continue to smoke and the smoke accumulates within the barbecue grill smoker. Once the food has been placed on the grill and the cooking process proceeds, it may be desirable to move rotatable surface 24 to its partially open position by nudging rotation fin 40 with the end of a cooking utensil. If one desires a very lightly smoked food product, rotatable surface 24 can be moved to a partially closed position where apertures 28 and opening 30 are only partially aligned until the desired amount of smoke fills the closed grill. After the grilling and smoking processes are completed, the food is removed and the grill is turned off to cool. The barbecue grill smoker can remain in place until it also has cooled down and can be easily lifted out of the grill. Lip 38 provides a means for moving the lid from its closed position to its open position for easy removal of the spent wood chips.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A barbecue grill smoker for producing a flavored smoke when a flavored smoke source is heated in a barbecue grill comprising:
a. a heat resistant receptacle having an interior cavity and a side wall,
b. a lid connected to the side wall of the receptacle, and
c. a smoker control mechanism positioned in the lid for regulating the rate of release of flavored smoke from the receptacle.

2. The barbecue grill smoker of claim 1, wherein the smoker control mechanism further comprises a first surface having at least one aperture and a second surface having at least one opening wherein the at least one aperture of the first surface is aligned with the at least one opening of the second surface to place the smoker control mechanism in an open position.

3. The barbecue grill smoker of claim 2, wherein the smoker control mechanism further comprises the first surface being rotatable and the second surface being stationary and a means for rotating the first surface about the second surface.

4. The barbecue grill smoker of claim 3, wherein the first surface is rotated relative to the second surface to move the at least one aperture of the first surface and the at least one opening of the second surface out of alignment to place the smoker control mechanism in a closed position.

5. The barbecue grill smoker of claim 3, wherein the first surface is rotated relative to the second surface to move the at least one aperture of the first surface and the at least one opening of the second surface into partial alignment placing the smoker control mechanism in a partially open position.

6. The barbecue grill smoker of claim 2, wherein the first surface has a plurality of apertures.

7. The barbecue grill smoker of claim 2, wherein the second surface has a plurality of openings.

8. A barbecue grill smoker for use in producing flavored smoke for flavoring food cooked in a barbecue grill comprising a receptacle for receiving a flavoring source, said receptacle having an opening, and a means for selectively covering and uncovering said opening for adjusting the amount of flavored smoke emanating from said receptacle.

9. The barbecue grill smoker of claim 8, wherein the means for selectively covering and uncovering said opening further comprises a smoker control mechanism.

10. The barbecue grill smoker of claim 9, wherein the smoker control mechanism further comprises a first surface having at least one aperture and a second surface having at least one aperture wherein the alignment of the at least one aperture on the first surface with the at least one aperture on the second surface selectively uncovers said opening.

11. The barbecue grill smoker of claim 10, wherein the flavoring source can be added to the receptacle through the uncovered opening.

12. The barbecue grill smoker of claim 8, wherein the means for selectively covering and uncovering said opening comprises a lid having a smoker control mechanism.
